(19) United States
(12) Patent Application Publication
(10) Pub. No.: US 2014/0003101 A1
(43) Pub. Date: Jan. 2, 2014

(54) VALVE CURRENT CONTROL METHOD BASED ON MODULAR MULTI-LEVEL CONVERTER

(71) Applicants: Guangfu Tang, Beijing (CN); Jie Yang, Beijing (CN); Shanshan Wang, Beijing (CN); Ming Kong, Beijing (CN); Dong Liu, Beijing (CN)

(72) Inventors: Guangfu Tang, Beijing (CN); Jie Yang, Beijing (CN); Shanshan Wang, Beijing (CN); Ming Kong, Beijing (CN); Dong Liu, Beijing (CN)

(73) Assignees: STATE GRID CORPORATION OF CHINA, Beijing (CN); CHINA ELECTRIC POWER RESEARCH INSTITUTE, Beijing (CN)

(21) Appl. No.: 14/005,265

(22) PCT Filed: Oct. 31, 2011
(86) PCT No.: PCT/CN2011/001814

§ 371 Date: Sep. 15, 2013

(30) Foreign Application Priority Data
Mar. 16, 2011 (CN) 201110063053.4

(51) Int. Cl. H02M 7/44

(52) U.S. Cl. CPC H02M 7/44
USPC 363/40

(57) ABSTRACT

The present invention relates to valve current control method based on modular multi-level converter, this method includes the control of the low frequency oscillations of the current and that of double frequency harmonic component; For said low frequency oscillations of the current, the control method includes some steps as below: first, calculate the half of the sum of the upper arm current and the lower arm current, it is the valve DC current component, said DC current component is arm circulating current; Secondly, comparing the actual value of the arm circulating current to setting value of that, the error is obtained, after some signal processing, additional output set voltage is obtained. For said the double frequency harmonic component of current, the control method includes some steps as below: firstly, figure out capacitor voltage fluctuation prediction value of the sub module; secondly, the output voltage is divided by the sum of the sub module reference voltage and the capacitor voltage fluctuation prediction value, and get the actual output set number of sub module. This method not only can realize stability of the dynamic performance of the system, but also can suppress the arm double frequency harmonic component, at the same time under the abnormal conditions of the AC system; the valve current has good output characteristics.

### RELATED APPLICATIONS

This application is a United States National Stage Application filed under 35 U.S.C 371 of PCT Patent Application Ser. No. PCT/CN2011/001814, filed Oct. 31, 2011, which claims the benefit of Chinese Patent Application Serial No. 201110063053.4, filed on Mar. 16, 2011, the disclosure of all of which are hereby incorporated by reference in their entirety.

### FIELD OF THE INVENTION

The invention relates to flexible direct current transmission (VSC-HDVC) filed and its control method, in particular, relates to a valve current control method based on modular multi-level converter.

### BACKGROUND OF THE INVENTION

Because of the flexible application performance of VSC-HVDC, it exhibits very broad application prospects in city power grid interconnection, the new energy gird and passive load power supply and other fields. And the modular multi-level converter, which is in last few years converter of arisen a converter, is fit for high voltage flexible direct current transmission field. It breaks the old market situation under which the two levels topology is the only choice for the flexible direct current transmission. It supplies anther choice for flexible direct current application.

Each modular multi-level arm consists of same number of sub modules and sub arms reactors, which makes the output voltage close to sine alternating current (AC) voltage by controlling in and out of the sub modules; therefore, it forms a stable operating point. At the same time, it can form a stable direct current (DC) voltage through complementary input capacitance of upper and lower arms of the same unit; thereby, it ensures the stable operation of system. In theory, valve current should be overlapped a DC and a work frequency AC, however, in practice operation, the voltage of each sub modules is different from each other because sub modules capacitors voltage keep charging and discharging constantly. This causes the distortion of the actual valve current, and this distortion not only could increase loss of the valve, but also could cause system instable.

During the analysis of the running mechanism of the modular multi-level converter, many researchers have proposed the converter current harmonic component problems, and analyzed the causes of frequency conversion circulating current component in valve current, Tu Qingrui et al “Mechanism Analysis on the Circulating Current in Modular Multi-level Converter Based HVDC ” (HIGH VOLTAGE ENGINEERING 2010, 36 (02), 547-552) analyzed double frequency circulating current mechanism of production. And it indicated that double frequency components can be suppressed by increasing the inductance value. But this method can't achieve no error control in double frequency components, and in high voltage applications, it is not economical to suppress double frequency components by increasing arms reactance value. Xu Zheng et al. proposed a method to suppress circulating current in the patent “a three-phase modular multi-level converter circulating current suppressing method” patent number (201010162065.8), which made the double frequency circulating current carried out dq transform, and gave additional setting quantity by decoupling control, so as to achieve the suppression of the double frequency circulating current. However, the method is only applicable to steady operation state, because under abnormal condition, converter three-phase transmitted powers differ, so the circulating current control method can't achieve good control effect.

At the same time, because each phase unit adopts capacitor and inductor in series form, so it is likely to resonate of each unit, and cause poor dynamic performance. These are practical application difficulties of the modular multi-level. How effective to control valve current is an important problems need to solve in the modular multi-level converter practical application at present.

FIG. 1 is a modular multi-level converter MMC structure; a modular multi-level converter is composed of multiple sub modules (SM) are stacked, FIG. 2 is a sub module (SM) structure; by control SM in and out, it can achieve a sinusoidal AC output voltage and set up a stable DC voltage, and form a stable operating point. Connects the two converters through the transmission lines, it can realize DC power transmission.

A modular multi-level converter is composed of three phase units in parallel, each unit is divided into upper and lower two arms; one side of the arms is connected to the AC output terminal, and another side is connected to the DC output end; each arm is composed of same number sub modules and a arm reactor in series, and the sub module is composed of a simple half bridge structure and a capacitor in parallel, or you can say it is composed of a bilateral switch and another identical electronic switch in parallel, and a capacitor in series. All the sub module series structure called valve, and each arm current is the valve current.

The valve current of modular multi-level converter is composed of two parts, one is the AC current from AC terminal, and another is the DC current from the DC terminal. During system running, the sub modules capacitor voltages of each arm are not entirely same, it leads AC output voltage distortion, the distortion will cause DC current from the DC terminals (commonly known as circulation component) distortion, it has common two kinds consequences, one is to cause double frequency circulation component; and another is to cause the current low frequency oscillation that is not easy to be stable, the double frequency circulation component result in loss increase of converter valve, affect system transmission efficiency seriously. And low frequency oscillation component may cause the system operating condition deteriorate gradually, and make the system cannot continue running. The possible reasons for the low frequency oscillation are the following:

1. Oscillation among each unit of converter;

2. Oscillation between the two DC transmission converters formed by DC lines;

3. The dynamic adjustment process in operation, such as the AC system fault, power transmission change, the startup and so on.

### BRIEF DESCRIPTION OF THE DRAWINGS

FIG. 1 is a modular multi-level converter MMC structure;

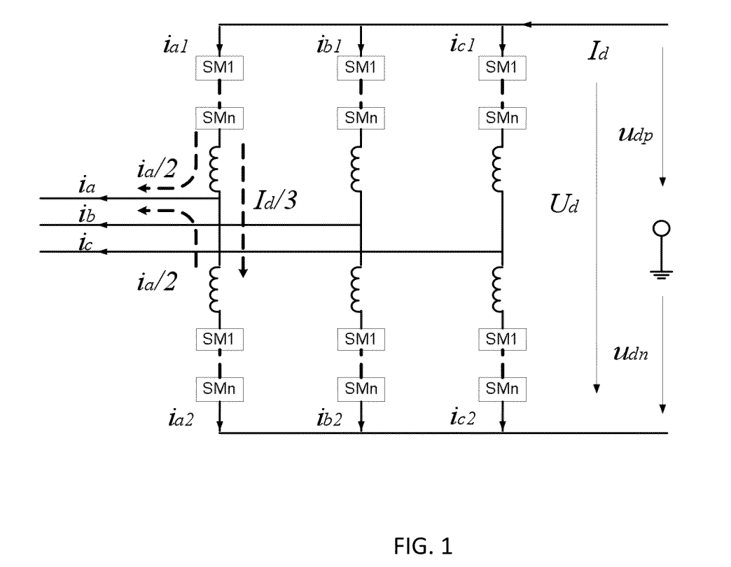

FIG. 2 is a sub module (SM) structure;

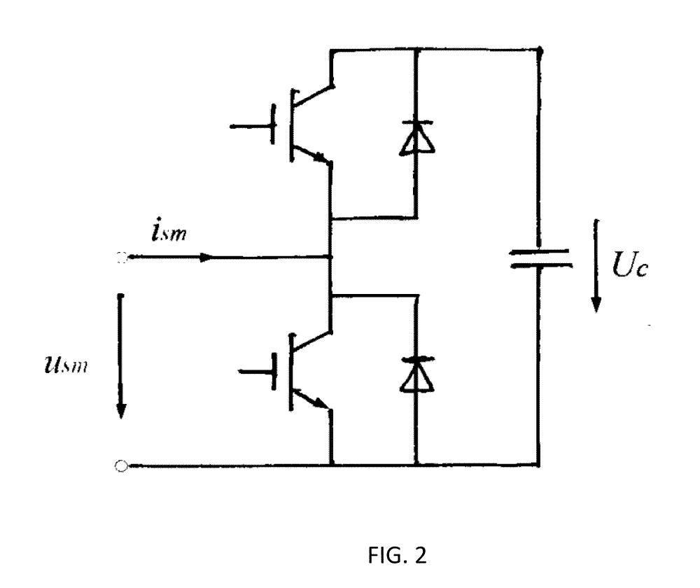

FIG. 3 is the schematic diagram of calculation method of arm circulation;

FIG. 4 is the schematic diagram of generation method of the additional voltage Uref1;

FIG. 5 is the schematic diagram of generation method of the additional voltage Uref2;

FIG. 6 is the schematic diagram of generation method of the arm output voltage.

### SUMMARY OF THE INVENTION

The invention provides a valve current control method based on modular multi-level converter, this method not only can realize stability of the dynamic performance of the system, but also can suppress the arm double frequency harmonic component, at the same time under the abnormal conditions of the AC system, the valve current has good output characteristics.

A valve current control method based on modular multi-level converter, is characterized that the valve current control is realized by controlling the low frequency oscillations of the current and the double frequency harmonic component;

For said low frequency oscillations of the current, the control method includes some steps as below:

A. calculate the half of the sum of the upper arm current and the lower arm current, it is the waive DC current component, said DC current component is arm circulating current;

B. Comparing the actual value of the arm circulating current to setting value of that, the error is obtained, after some signal processing, additional output set voltage is obtained;

For said the double frequency harmonic component of current, the control method includes some steps as below:

a. Figure out capacitor voltage fluctuation prediction value of the sub module;

b. The output voltage in said step B is divided by the sum of the sub module reference voltage and the capacitor voltage fluctuation prediction value, and get the actual output set number of sub module.

First technical scheme provided by the invention is preferred: wherein said controlling the low frequency oscillations of the current includes oscillation circulating current control among arms and that between two converters.

Second technical scheme provided by the invention is preferred: wherein said oscillation circulating current control among arms includes some steps as below:

1) Firstly, add the upper arm valve current and the lower arm valve current, and then divided by 2, and got the actual value of the DC current component; said DC current component is called arm circulating current;

2) Then, the arm circulate current minus the average of the three-phase arm circulation values, and obtained the oscillation circulating current among arms;

3) Comparing the actual value of the arm circulating current to setting value of that, get the error, after some signal processing, additional output set voltage Uref1 is obtained; said signal processing method is through a proportional controller and an integral regulator.

Third technical scheme provided by the invention is preferred: wherein said oscillation circulating current control between two converters includes some steps as below:

First, we measure total energy of all sub modules of converter, then compare the total energy to the set value and obtain error, and get required DC current set value after a certain signal processing; said scheme of signal processing method is through a proportional controller and an integral regulator;

Secondly, comparing DC current set value to actual DC current value, the error is obtained; After the signal processing, required additional output set voltage Uref2 is obtained; said scheme of signal processing method is through a proportional controller and an integral regulator;

Finally, adding the Uref1 and the Uref2, the voltage additional Uref which suppresses the low frequency oscillation is obtained.

Fourth technical scheme provided by the invention is preferred: wherein for said double frequency harmonic component, the control steps includes: firstly, figure out capacitor voltage fluctuation prediction value of the sub module; secondly, add said actual sub module voltage fluctuation prediction value and the sub module reference voltage, arm output set voltage Upref which is the update of said low frequency oscillations additional voltage is divided by the sum of the sub module reference voltage and the capacitor voltage fluctuation prediction value, and get the actual output set number N of sub module.

Compared with the prior art, a valve current control method based on modular multi-level converter provided by the present invention has the following advantages:

1. It solves the system oscillation may be caused by system dynamic response;

2. It realizes the inhibition of double frequency circulation of arms, and reduces the loss of the system;

3. It realizes the inhibition of arms circulation under the abnormal conditions of the AC system;

4. It solves significant difficulties to achieve engineering application of the modular multi-level converter (Modular Multi-level Coverter, MMC).

### DETAILED DESCRIPTION OF EMBODIMENTS

The detail of the embodiments is described as below incorporated with the figures by way of cross-reference for the present invention.

The valve current control of modular multi-level converter can be divided into the low frequency oscillation current control and the double frequency harmonic component control two control layers, these control schemes are different. The following will introduce the low-frequency oscillation current control and the double frequency harmonic component control.

1. For low frequency oscillations of the current, the control can be divided into oscillation circulating current control among arms and that between two converters.

(1) the oscillation circulating current control steps of among arms is as following:

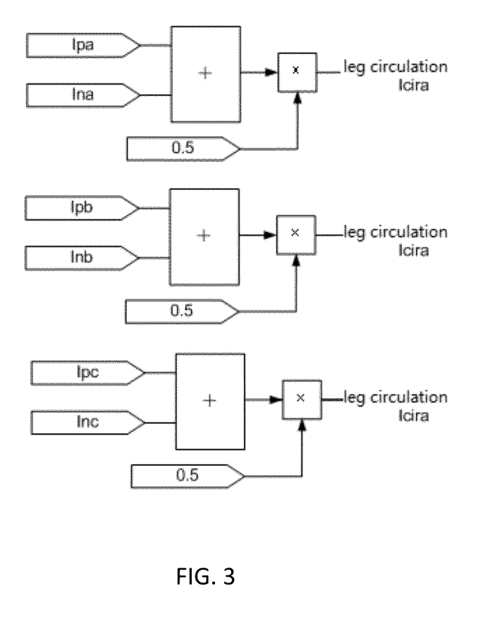

FIG. 3 is the schematic diagram of calculation method of arm circulation. As FIG. 3 shown, first add the upper arm valve current and the lower arm valve current, and then divided by 2, and got the actual value of the DC current component (arm circulating current) of the valve;

Then, the arm circulate current minus the average of the three-phase arm circulation values, and obtained the oscillation circulating current among arms.

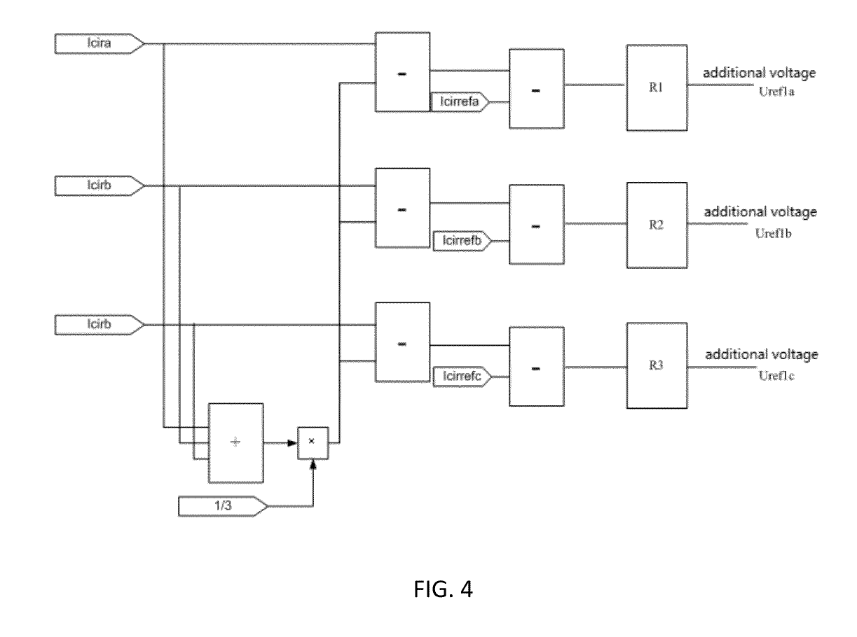

Comparing the actual value of the arm circulating current to setting value of that, get the error, after some signal processing, additional output set voltage Uref1 is obtained, the typical scheme of signal processing is through a proportional controller and an integral regulator, as shown in FIG. 4, FIG. 4 is the schematic diagram of generation method of the additional voltage Uref1.

And the arm circulation set value can be generated by the total energy or voltage of each arm module compared to each other, and after certain signal processing, the typical scheme of signal processing is through a proportional controller with integral regulator.

(2) For oscillation circulating current control between two converters, the steps is following:

First, we measure total energy of all sub modules which control the modular multi-level converters. And then, compare the total energy to the set value (the setting value is setting requirements for the total energy converter module, generally is a constant value, in figure is Usref, and correspondingly, Us is the actual total energy of converter module), and obtain error, and get required DC current set value after a certain signal processing, the typical scheme of signal processing method is through a proportional controller and an integral regulator.

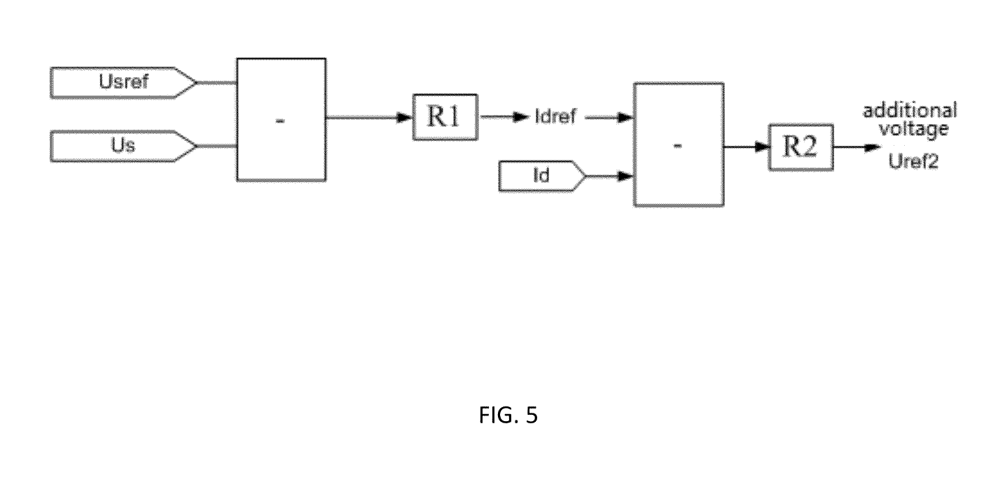

Secondly, comparing DC current set value to actual DC current value, the error is obtained; after the signal processing, required additional output set voltage Uref2 is obtained; a typical scheme of signal processing method is through a proportional controller and an integral regulator, as shown in FIG. 5, FIG. 5 is the schematic diagram of generation method of the additional voltage Uref2.

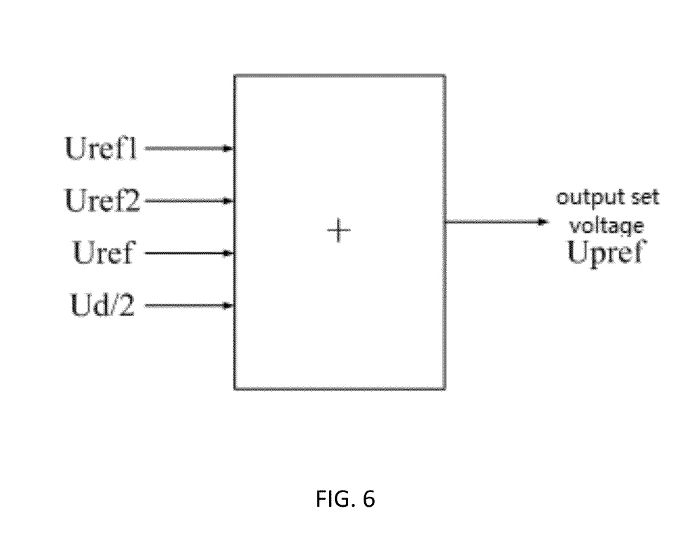

Finally, adding the Uref1 and the Uref2, the voltage additional Uref which suppresses the low frequency oscillation is obtained. Comprehensive basic output voltage set Uref and DC voltage, we can get the actual arm input voltage Upref, as FIG. 6 shown, FIG. 6 is the schematic diagram of generation method of the arm output voltage.

2. For the double frequency harmonic component of arm circulation, its control steps is following:

First, figure out capacitor voltage fluctuation prediction value of the sub module;

Secondly, the final set output voltage Upref is divided by the sum of the sub module reference voltage and the capacitor voltage fluctuation prediction value, and get the actual output set number N of sub module.

The valve current control method based on modular multi-level converter provided by the invention not only can realize stability of the dynamic performance of the system, but also can suppress the arm double frequency harmonic component, at the same time under the abnormal conditions of the AC system, the valve current has good output characteristics.

At last, in this description of the embodiments, we have detail describe the present invention according to a particular example. The detail embodiment is one example of the invention but not the only one, so the person in this field must be understand that all the alternatives and other equal and/or similar examples are all within the range of the invention and they are all consistent with the spirits of this invention, are all protected by our claims.

What is claimed is:

1. A valve current control method based on modular multi-level converter, is characterized that the valve current control method includes steps as below:
(1) controlling the low frequency oscillations of the current; and
(2) controlling the double frequency harmonic component;
For the low frequency oscillations of the current, the control method includes some steps as below:
A. calculating the half of the sum of the upper arm current and the lower arm current, it is the valve DC current component, said DC current component is arm circulating current; and
B. comparing the actual value of the arm circulating current to setting value of that, the error is obtained, after some signal processing, additional output set voltage is obtained;
for the double frequency harmonic component of current, the control method includes some steps as below:
a. figuring out capacitor voltage fluctuation prediction value of the sub module; and
b. dividing the output voltage in said step B by the sum of the sub module reference voltage and the capacitor voltage fluctuation prediction value, and get the actual output set number of sub module.

2. A valve current control method based on modular multi-level converter according to claim 1, is characterized that, wherein said controlling the low frequency oscillations of the current includes oscillation circulating current control among arms and that between two converters.

3. A valve current control method based on modular multi-level converter according to claim 2, is characterized that, wherein said oscillation circulating current control among arms includes some steps as below:
1) adding the upper arm valve current and the lower arm valve current, and then divided by 2, and got the actual value of the DC current component; said DC current component is called arm circulating current;
2) subtracting the average of the three-phase arm circulation values from the arm circulate current , and obtaining the oscillation circulating current among arms;
3) comparing the actual value of the arm circulating current to setting value of that, get the error, after some signal processing, additional output set voltage Uref1 is obtained; said signal processing method is through a proportional controller and an integral regulator.

4. A valve current control method based on modular multi-level converter according to claim 2, is characterized that, wherein said oscillation circulating current control between two converters includes some steps as below:
measuring total energy of all sub modules of converter, then compare the total energy to the set value and obtain error, and get required DC current set value after a certain signal processing; said scheme of signal processing method is through a proportional controller and an integral regulator;
comparing DC current set value to actual DC current value, the error is obtained;
after the signal processing, required additional output set voltage Uref2 is obtained;
said scheme of signal processing method is through a proportional controller and an integral regulator;
adding the Uref1 and the Uref2, the voltage additional Uref which suppresses the low frequency oscillation is obtained.

5. A valve current control method based on modular multi-level converter according to claim 1, is characterized that, wherein for said double frequency harmonic component, the control steps includes: firstly, figure out capacitor voltage fluctuation prediction value of the sub module; secondly, add said actual sub module voltage fluctuation prediction value and the sub module reference voltage, arm output set voltage Upref which is the update of said low frequency oscillations additional voltage is divided by the sum of the sub module reference voltage and the capacitor voltage fluctuation prediction value, and get the actual output set number N of sub module.
